(19) United States
(12) Patent Application Publication
(10) Pub. No.: US 2005/0005270 A1
(43) Pub. Date: Jan. 6, 2005

(54) Service platform application distribution manager

(76) Inventors: Tim Bucher, Los Altos, CA (US); Tim Sullivan, Portola Valley, CA (US)

Correspondence Address: WORKMAN NYDEGGER (F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 10/822,313

(22) Filed: Apr. 12, 2004

Related U.S. Application Data
(60) Provisional application No. 60/462,273, filed on Apr. 11, 2003.

(51) Int. Cl. G06F 9/44; G06F 9/445

(52) U.S. Cl. 717/173; 717/178

(57) ABSTRACT

A service distribution system configured to provide initial and follow-up services to a local device over a distributed data connection. Initial services include downloading software packages and installing them on the device that is remote with respect to the service distribution system. Follow-up services include subscribing to receive updates or notifications about a particular product when they become available. The system analyzes the hardware resources available on the remote device in order to only offer services that are compatible with the remote device's resources. In addition, the system has the ability to analyze the software and hardware resources available on the remote device and suggest available services that would enhance the already existing resources on the remote device. The system is configured to receive new software from an outlet that would enable it to offer new services.

### CROSS-REFERENCE TO RELATED APPLICATIONS

### Related Applications

This application claims the benefit of U.S. Provisional Application No. 60/462,273, filed Apr. 11, 2003, and entitled SERVICE PLATFORM APPLICATION DISTRIBUTION MANAGER, which is hereby incorporated herein by reference.

### BACKGROUND OF THE INVENTION

1. The Field of the Invention

This invention relates generally to the field of computer networking and data storage. In particular, embodiments of the present invention relate to a remote service platform in which local devices can download applications from remote software vendors.

2. The Relevant Technology

Computer and data communication networks continue to proliferate due to declining costs, increasing performance of computer and networking equipment, and increasing demand for communication bandwidth. Communication networks, including wide area networks (“WANs”) and local area networks (“LANs”), allow increased productivity and utilization of distributed computers or stations through the sharing of resources, the transfer of voice and data, and the processing of voice, data and related information at the most efficient locations. The most commonly used WAN in existence is the Internet which provides access to numerous documents throughout the world. Unlike some networks, the Internet is a decentralized network in which individual computer devices act as hosts and the Internet simply provides a means for devices to connect to one another throughout the world. Generally, every computer device that is connected to the Internet is given a unique Internet protocol (IP) address that can be used by other devices to establish a connection over the Internet. In this way documents and other data can be easily shared across far distances. In general, computers that are connected to the Internet create documents referred to as “web pages” or “websites” that can be viewed by any computer connected to the Internet.

The Internet was originally used primarily for scientific, governmental, educational, and business purposes by sending documents and other information from one location to another. Because of the large number of individuals with access to the Internet, it has become a very popular medium in which to provide numerous products and services to a large segment of the population. An increased number of retailers and manufacturers are designing websites to provide information and or sell products directly to customers. Companies create websites to advertise their products and provide information about their products to customers in an efficient manner. One of the largest obstacles in web site design is creating a site that is user friendly and encourages users to read the information contained on the site. Because of how easily users can switch from one website to another, websites must be designed to capture the attention of users for an extended period of time in order to convey the desired information. For this reason it is also important to streamline processes as much as possible so as not to lose the attention of customers. For example, if a website requires a user to fill out a three-page questionnaire before displaying any information, it is very unlikely the information will be conveyed to anyone. Likewise, if a website includes a well organized and visually attractive information scheme, it is very likely that users will read or view the information on the website.

Another popular form of website is a virtual store that includes the ability for users to download software products onto their local computer or device. Computer software is particularly well suited for sale on the Internet because software can be delivered over the Internet. Purchasing software on the Internet eliminates the need for a customer to physically go to a store and purchase a software package and then take it to their local computer before installing it. These websites often include a list of software products or packages that are available for download and a brief description of each of the products. Unfortunately, these sites still require a user have the sophistication to know which products to select for download. For example, if a user wishes to purchase a software program that will allow him to interface his digital camera with his personal computer, he will then need to know technical details about the camera, the computer, and the data interface between the camera and computer before having the ability to select a software package to download. If the user purchases a software package without knowing this information it is possible that the software package will not be compatible with one of the devices and therefore not function properly. This requirement for users to possess technical knowledge about their situation before selecting a product is contrary to the Internet concept of streamlining processes in order to make things simpler for a user.

In addition, there are follow-up services that relate to downloading software packages that are not offered by existing website stores. These follow-up services include notifying a customer when a particular update, upgrade, or expansion module is available for a particular software package. If these services are not available, users are forced to periodically check if the updates, upgrades, or expansion modules are available in order to stay up to date with their software packages. In most instances, customers do not check for such updated or upgraded packages and therefore use an outdated software package that may possess errors.

Although the nature of software lends itself to being easily sold and distributed using the Internet, the foregoing problems have limited the extent to which software is actually purchased using the Internet. Because of some of the practical problems associated with purchasing software from virtual stores, a large number of customers purchase software from physical retailers. However, the need to be physically present in a store to make purchases in this way represents an obstacle that reduces the amount of software that is sold compared to the volume of software that could be sold if the practical problems described above were to be overcome.

### BRIEF SUMMARY OF EMBODIMENTS OF THE INVENTION

These and other problems in the prior art are addressed by embodiments of the present invention, which relates to a remote service distribution system configured to provide initial and follow-up services associated with software sales to a local device over a distributed data connection. Initial services include downloading software packages and installing them on the local device. Follow-up services include subscribing to receive updates or notification about a particular product when they become available. The system is able to analyze the hardware resources available on the local device in order to only offer services that are compatible with the local device's resources. In addition, the system has the ability to analyze the software and hardware resources available on the local device and suggest available services that would enhance the already existing resources on the local device. The system is configured to receive new software from an software outlet that enables the system to offer new services.

The service distribution systems can be associated with a service platform that is implemented to provide any of a variety of other services for network appliances used in local area networks. For example, the network appliances used in combination with the service platform can be consumer and business electronics devices that provide Internet connectivity, data backup and collaboration functionality, local wireless networking, and the like. The service platform that is accessible over the Internet for such network appliances can be leveraged to conveniently distribute software on behalf of software vendors, including third party software vendors.

According to one aspect of the invention, the remote service distribution system generally includes a storage device, an Internet interface, and an analysis module. The storage device is a device that is capable of storing data packets such that they can later be downloaded. The Internet interface is a software module that creates a public interface and a private interface that are accessible over the Internet. The private interface is used to connect with an outlet for receiving new software pertaining to new services. The private interface also includes security features to prevent unwanted data from being uploaded to the remote service distribution system. The public interface is a publicly accessible interface that allows local devices to connect and purchase services from the remote service distribution system. Although publicly accessible on the Internet, the public interface provides local devices with only limited accessibility to the remote service distribution system for security purposes.

The Internet interface is connected to the storage device in order to upload and download stored data packets pertaining to available services. The Internet interface is also connected to an analysis module that identifies and analyzes resources available on a local device that is connected to the public interface. Resources include both software and hardware resources that relate to the capabilities of the local device. The analysis module analyzes the identified resources on the local device in order to filter out services that are incompatible with the resources on the local device. In addition, the analysis module can analyze the identified resources on the local device and suggest services which would enhance the identified resources, such as expansion modules, updates, or upgrades for a particular software package. The local device that can connect to the remote service distribution system can be any individual computer device or computer system that is capable of communicating over the Internet. For example, the local device can be an individual computer, or a computer that is networked using an Ethernet network an appliance based network or another local area network.

The method for delivering services to a local device through a remote service distribution system can be performed by initially establishing a connection between the remote service distribution system and the local device. Once a connection is established, the resources on the local device are identified using the analysis module on the remote service distribution system. The process of identifying resources includes attempting to automatically identify the resources on the local device by accessing a data structure on the local device that describes the available resources or prompting the user of the local device to manually enter the resources if they cannot be automatically obtained. A list of services compatible with the resources on the local device is then displayed to the local devices.

The process of displaying the compatible services available on the remote service distribution system includes analyzing the identified resources in relation to the available services to determine which services are compatible. A request is then received from the local device to perform at least one service. In general, requesting services requires the user of the local device to transfer money in some manner to the remote service distribution system before they are performed. The requested services are then performed and communication information about the local device is stored in order to communicate with the local device at a later time. The communication information about the local device is only stored if the requested services include follow-up services such as automatic updates to particular software packages. A connection is then reestablished between the remote service distribution system and the local device at a later time in order to perform requested follow-up services.

One method for installing additional services on a remote service distribution system from an outlet includes initially establishing a connection between the remote service distribution system and the outlet. Once the connection is established, the remote service distribution system receives new software from the outlet across the Internet and through the private interface. The new software generally relates to either new services or new software for the operation of the remote service distribution system. The new software is then stored on the remote service distribution system and the public interface is updated to reflect additional software available for download. The new software available for download is generally included in a service that is listed in the public interface for a user of a connected local device to purchase.

The remote service distribution system of the invention provides significant advantages compared to conventional systems. According to the invention, the system is accessible publicly such that any device capable of connecting to the system is able to purchase services. In addition, the dynamic ability of the system to filter out services that are not compatible with a particular local device ensures that the interface between the local device and the system is the most efficient possible. The system is also configured to suggest services that would enhance identified resources on the local device to further entice a user of the local device to purchase a service. In addition, the system is able to automatically perform follow-up services at a later time when the data becomes available. Existing service distribution systems simply provide the ability for users to download software in exchange for a fee. These conventional systems do not dynamically identify the needs of the particular local device nor do they suggest services that would enhance the capabilities of the local device. Therefore, the system and methods of distributing services from a remote service distribution system according to the invention are more efficient than conventional techniques.

The foregoing, together with other features and advantages of the present invention, will become more apparent when referred to the following specification, claims and accompanying drawings.

### BRIEF DESCRIPTION OF THE DRAWINGS

In order that the manner in which the above-recited and other advantages and features of the invention are obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 illustrates a functional block diagram of a distributed networking environment configured to implement one embodiment of the present invention to enable a remote service distribution system to remotely distribute services to a local device across the Internet;

FIG. 2A illustrates an individual computer embodiment of a local device;

FIG. 2B illustrates a local area network embodiment of a local device;

FIG. 2C illustrates an appliance based network embodiment of a local device;

FIG. 3 illustrates a logical flow chart of a method for delivering services to a local device through a remote service distribution system;

FIG. 4 illustrates a method for installing additional services on a remote service distribution system from an outlet; and

FIG. 5 illustrates a method for suggesting enhancement services to a local device through a remote service distribution system.

### DETAILED DESCRIPTION OF THE PREFERRED EMBODIMENTS

Reference will now be made to the drawings to describe presently preferred embodiments of the invention. It is to be understood that the drawings are diagrammatic and schematic representations of the presently preferred embodiments, and are not limiting of the present invention, nor are they necessarily drawn to scale.

In general the present invention relates to a remote service distribution system that provides initial and follow-up services associated with software sales to a local device over a distributed data connection. Initial services include downloading software packages and installing them on the local device. Follow-up services include subscribing to receive updates or notifications about a particular product when they become available. The system can analyze the hardware resources available on the local device in order to only offer services that are compatible with the local device's resources. In addition, the system can analyze the software and hardware resources available on the local device and suggest available services that would enhance the already existing resources on the local device. The system receives new software from a software outlet that enables the system to offer new services.

A “service” as used in this application describes a software based routine, such as the installation or upgrade of a computer program that performs one or more functions. For example, the installation of a word processing program falls under the general definition of a service. A service can also be broken up into two more descriptive categories of an “initial service” and a “follow-up service”. An initial service includes initial routines that are performed in order to install or setup a particular computer program. For example, downloading a new software module and installing it on a local personal computer constitutes an example of an initial service. A follow-up service is a secondary routine that is performed in conjunction with an existing software module or program. For example, downloading and installing a software upgrade for an existing software module represents an example of a follow-up service because it is performed after a user requests the service.

A “resource” as used in this application pertains to a characteristic of a particular computing device that relates to which services the particular computing device is capable of implementing. A resource can then be subdivided into “software resources” and “hardware resources”. One example of a hardware resource is the processing speed of a personal computer, because certain software modules cannot be installed or upgraded on a computer that has a processing speed below or above a particular value. Therefore, the processing speed of a personal computer relates to which resources the personal computer is capable of implementing. Likewise, a software resource also relates to which services the particular device is capable of implementing. For example, a handheld computer that is loaded with a computer aided drafting (CAD) program is able to utilize software expansion modules for CAD drawings. If the handheld computer does not have a CAD program, any CAD related services will be useless. Therefore, whether a particular computer has a CAD program affects which services it is capable of implementing and utilizing.

A “software module” as used in this application pertains to a conceptual grouping of a particular segment of a computer program. For example, a word processing program may include both a software module for displaying text and a different software module for printing text. By describing these components of a word processing program it is easier to understand the various elements or routines that are performed within the word processing program. This description does not imply any specific segregation of computer code, but merely describes one possible software architecture in a manner that is easily understood.

As used herein, the terms “local” and “remote” are relative and are used for convenience in describing the relationship between certain components of the systems described herein. Because these terms describe the relationship between different components, a certain component can accurately be described as being either local or remote, depending on the reference point. For example, the service distribution systems are described herein as being remote with respect to local devices. However, it is equally valid to describe to describe the devices as being remote with respect to the service distribution systems.

I. Exemplary Network Architecture

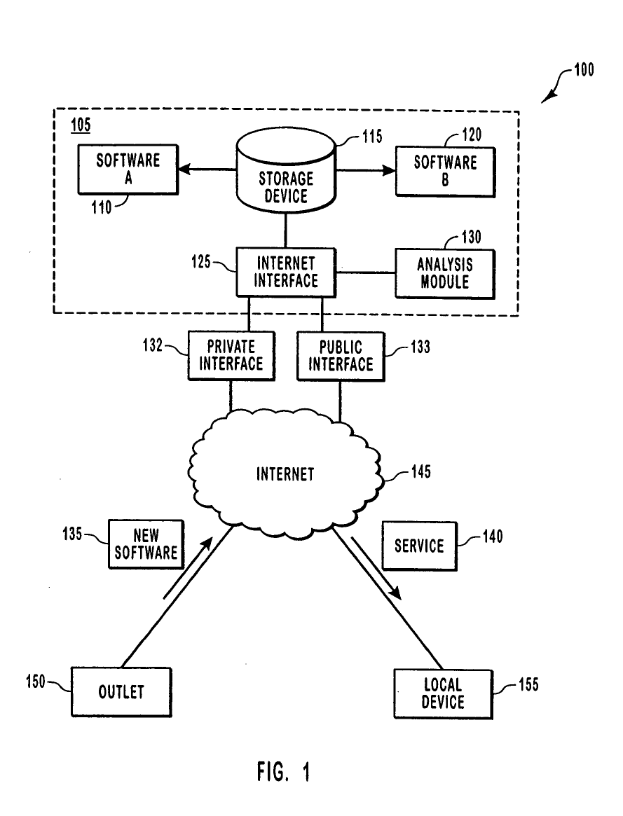

FIG. 1 is a functional block diagram illustrating a distributed networking environment 100 configured to implement one embodiment of the present invention to enable a remote service distribution system 105 to remotely distribute services to a local device 155 across the Internet 145. The remote service distribution system 105 further includes a storage device 115, an Internet interface 125 and an analysis module 130. The storage device 115 is a writeable data storage device such as a hard disk, a CD-ROM, a tape drive, etc. The storage device 115 further includes software A 110 and software B 120. Software A 110 and B 120 represent software modules that are stored on the storage device 115 in a digital format. Software modules or data segments can be copied onto the storage device 115 or removed at any time. The storage device 115 is directly connected to the Internet interface 125 to enable data segments and software modules to be transferred back and forth in an efficient manner.

The Internet interface 125 is a software module that displays a public interface 133 on the Internet 145 which is accessible publicly. Whenever a user of local device 155 transmits a request using, for example, a Uniform Resource Identifier (URI) associated with public interface 133, the local device 155 establishes communication with the remote service distribution system 105 through the public interface 133. The public interface 133 generated by the Internet interface 125 displays a list of various services of the remote service distribution system 105 that are publicly available to external devices, such as local device 155. The public interface 133 also provides a purchasing system such that local devices 155 can purchase one or more of the available services listed on the public interface 133. The remote service distribution system 105 utilizes an online purchasing system, such as a shopping cart to facilitate the transfer of funds and the distribution of services.

Services include initial services and follow-up services. Initial services are generally one-time downloads of particular software packages, whereas follow-up services include automatically receiving updates or notifications pertaining to software packages. For example, if a user of the local device 155 purchases an initial service A over the Internet 145, the Internet interface 125 then automatically transfers software A 110 in the form of a service 140 from the storage device 115 to the local device 155. Software A 110 is preferably configured to automatically install itself on the local device 155, such that the process requires as little user input as possible. Alternatively, after the user of the local device 155 purchases initial service A, he is forwarded to a download page that enables him to manually download software package A 110 in the form of a service 140. Other methods of transferring the software package relating to a purchased service are contemplated and included in the context of this invention.

In addition, if follow-up services are to be performed, such as checking in the future for a new version or upgrade of the software that is initially downloaded, the local device 155 or a network appliance or other computer associated with the local device is configured to store information specifying that the follow-up services are to be performed. For example, if a user of local device 155 purchases a follow-up service to automatically update a particular computer program, the information that specifies that follow-up services are to be performed defines when and how that follow-up services are to be initiated. Typically, after a defined period of time, the local client is to establish communication with the remote service distribution system 105 so that the follow-up services can be performed. Preferably, the process of reestablishing communication at the defined time and initiating the follow-up services is automated so that the user does not need to initiate the process.

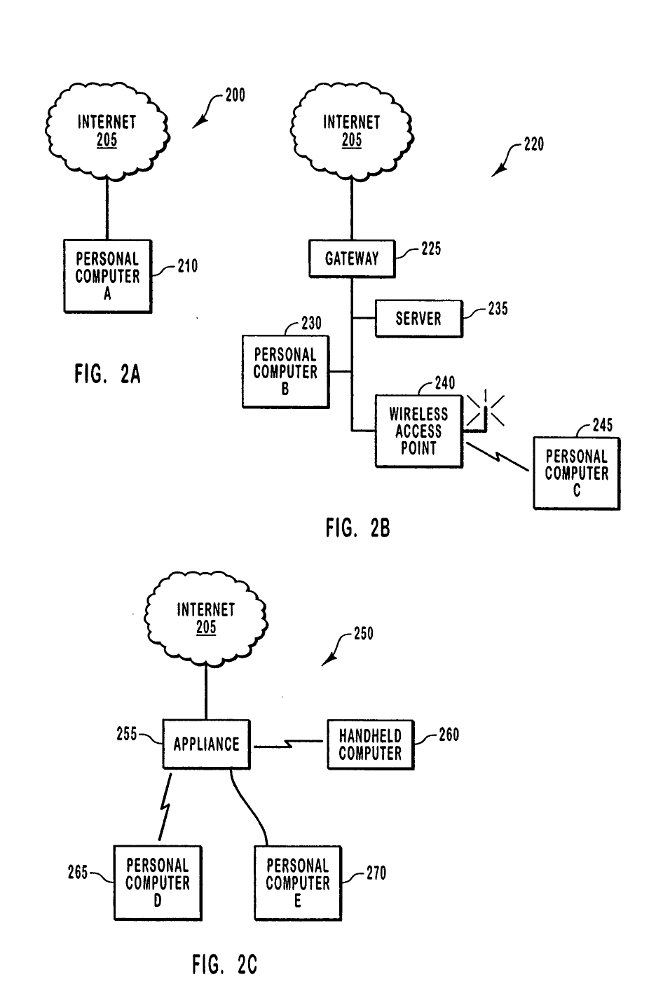

As further described below, the process of reestablishing communication with the remote service distribution system 105 can be conveniently initiated if the local device 155 is associated with a network appliance or other computer that acts as a gateway to the Internet and stores the information specifying that the follow-up services are to be performed. For instance, FIG. 2C, which is described in greater detail below, illustrates a network appliance 255 that can be conveniently used to control this process.

The Internet interface 125 of FIG. 1 also provides a private interface 132 that can be connected to an outlet 150 to facilitate uploading new software packages or data segments from the outlet 150 to the remote service distribution system 105. The outlet 150 is a computer system that is capable of establishing a data connection over the Internet 145. The outlet 150 connects to the remote service distribution system 105 through the Internet 145 using, for example, a URI associated with the private interface 132. Unlike how a local device connects to the remote service distribution system 105, the outlet 150 connects through a private interface 132 that is not publicly available on the Internet 145. Once connected, the outlet can transfer new software 135 to the remote service distribution system 105, where it is stored on the storage device 115. Before the outlet 150 is allowed to connect to the remote service distribution system 105, the private interface 132 requires the outlet 150 to comply with security requirements in order to become authorized to transfer new software 135 to the remote service distribution system 105. The security requirements utilized by the private interface 132 in securing the private interface include encryption, password authentication, and location authentication.

The new software 135 can be any software package or data segment. For example, the new software 135 may be a new software package that can be directly downloaded from the remote service distribution system 105 as an initial service. In addition, the new software 135 can contain an additional data segment that can be used to update the list of available services on the public interface 133 to reflect a new initial service pertaining to downloading the new software 135. Alternatively, the new software 135 may be unrelated to new services, such as a data pertaining to revising the interface provided by the public interface 133 to local devices.

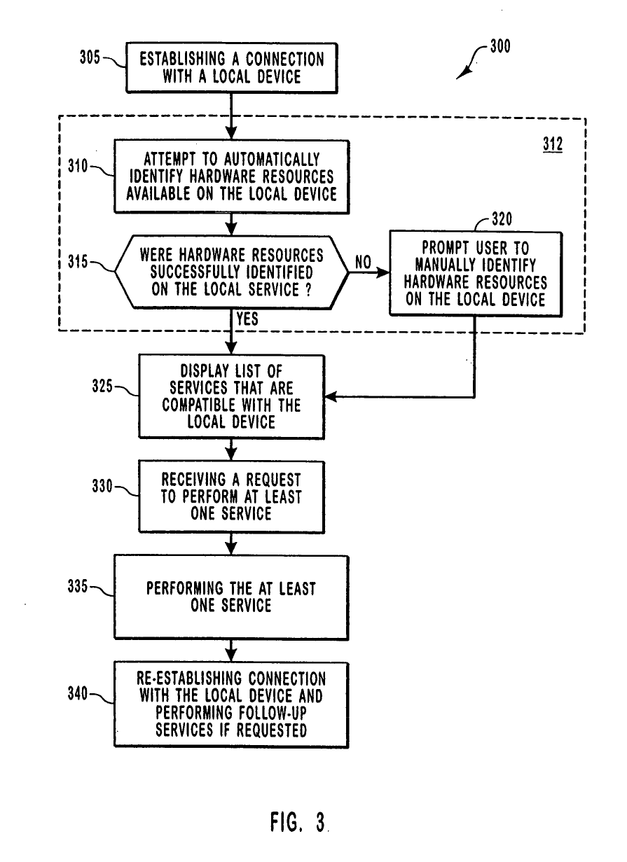

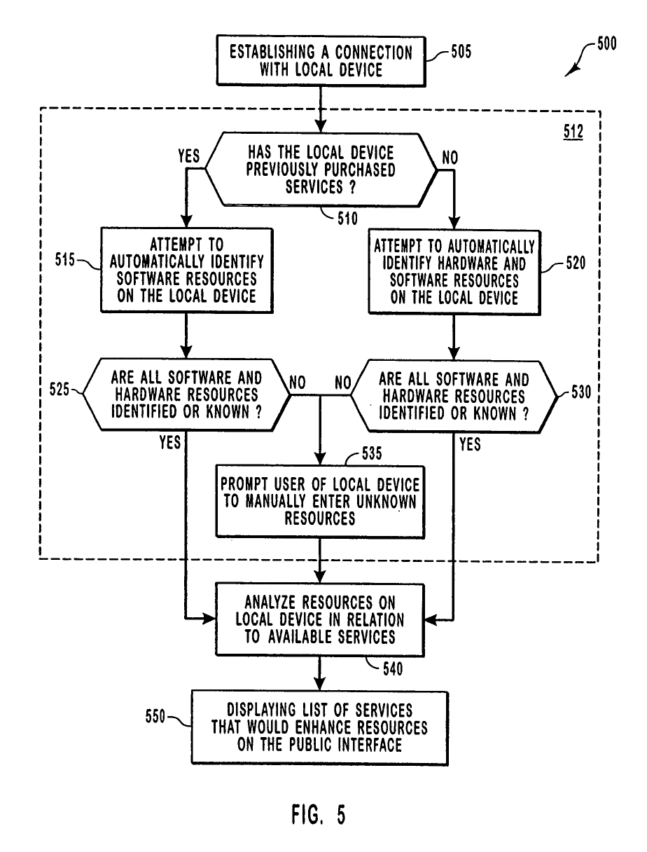

The Internet interface 125 is also connected to an analysis module 130 that is used to identify and analyze resources available on a local device 155 in relation to the available services on the remote service distribution system 105. The process of identifying and analyzing resources on a local device used by the analysis module 130 is described in more detail with reference to FIGS. 3 and 5. The analysis module 130 identifies hardware or software resources on a local device 155 that is connected to the public interface 133. The identified resources on the local device 155 are then analyzed in relation to the available services on the remote service distribution system 105. If the identified resources include the hardware resources on the local device 155, the analysis module 130 filters the list of available services displayed by the public interface 133, such that only services that are compatible with the hardware resources of the local device 155 are displayed. For example, if the local device 155 does not have an attached scanner, the analysis module 130 filters the list of services displayed by the public interface 133 to not display an initial service of downloading a scanning software package. If the identified resources include the software resources on the local device, the analysis module 130 can make suggestions regarding particular available services that could enhance existing software resources on the local device 155. For example, if the local device 155 includes software resources pertaining to spreadsheets, the analysis module 130 can inform the local device 155 of particular services available on the remote service distribution system 105 that could enhance the spreadsheet capabilities of the local device 155.

The functionality of the remote service distribution system 105 can be implemented in many different computer architectures other than the one described above. The software and hardware components of the remote service distribution system 105 can be combined or altered in other ways to perform the same function. For example, the private interface 132 and public interface 133 can be combined in a manner that maintains the functionality of both interfaces. Likewise, the functionality of the analysis module 130 can be incorporated into the Internet interface 125 without diverging from the concepts disclosed herein. In addition, the local device 155 and or the outlet 150 can connect the remote service distribution system 105 across other media, such as a wide area network (WAN), a wireless network, or a telephone connection.

II. Alternative Local Device Embodiments

The local device 155 illustrated in FIG. 1 can be implemented as many different types of computer systems, including an individual computer, a local area network, or an appliance based network. FIGS. 2A, 2B and 2C illustrate these different computer systems and briefly describe their functionality. Numerous other computer systems can be used as a local device 155 that are consistent with the teachings of this invention. Each of these computing systems has the ability to communicate over the Internet 145 and therefore has the ability to interface with the remote service distribution system 105.

FIG. 2A illustrates an individual computer embodiment of a local device, designated generally at 200. In this embodiment, personal computer A 210 is connected to the Internet 205 directly using a data connection such as a DSL, cable, dial-up, wireless, etc. Personal computer A 210 includes hardware and software resources that allow it to communicate directly over the Internet 205. For example, if personal computer A 210 connects to the Internet 205 over a dial-up connection, an internal or external modem is included as part of personal computer A 210. Personal computer A 210 can be any stand alone computing system, such as a handheld computer, a desktop personal computer, a laptop or portable personal computer, a digital cell phone, etc.

FIG. 2B illustrates a local area network (LAN) embodiment of a local device, designated generally at 220. LANs are commonly used to interconnect computer devices within a small geographical area such as an office building or a house. A LAN can interconnect numerous different types of computer devices that include network interface device. In the illustrated embodiment, the local device 220 is an Ethernet based LAN that includes a gateway 225, a server 235, a personal computer B 230, a wireless access point 240 and a personal computer C 245.

Since all of the computer devices in a LAN are interconnected, only one device needs to be connected to the Internet in order to enable all of the devices to communicate over the Internet. The device that is connected to the Internet 205 in a LAN 220 is generally referred to as a gateway 225, because it provides a gateway to the Internet 205 for all of the other computer devices. The server 235 is a computer device that monitors various resources within the LAN 220. For example, the server 235 may be a file server that includes a data storage device that is shared throughout the LAN 220. Personal computer B 230 is a computer device that is directly connected to the LAN 220 via a network interface device such as a network interface card (NIC). Personal computer B 230 can communicate with any of the other devices in the LAN 220 in addition to the Internet 205. Personal computer B 230 includes a user interface by which a user can direct the operation from a high level. Likewise, personal computer C 245 can also communicate with any of the other devices in the LAN 220 and the Internet 205. Personal computer C 245 is connected to the LAN 220 via a wireless data connection and a wireless access point 240. Personal computer C 245 also includes a user interface that allows a user to direct the operation and communications from a high level.

FIG. 2C illustrates an appliance based network embodiment of a local device, designated generally at 250. The illustrated appliance based network 250 includes a network appliance 255, a personal computer D 265, a personal computer E 270, and a handheld computer 260. An appliance 255 is a computer device that is capable of connecting to the Internet 205 and acting as a hub for all data communications between devices in a appliance based network. An appliance 255 is also capable of performing other network device functions, such as those associated with a file server, a router, a firewall, etc. The appliance 255 is connected to the internet 205 via a data connection, such as a DSL, cable, dial-up, T1, T2, etc. The appliance includes various software and hardware resources to enable it to communicate across interfaces using any of various formats. For example, the appliance 255 includes an IEEE 802.11 network interface card and appropriate software to allow it to communicate wirelessly with personal computer D 265 and handheld computer 260 using an IEEE 802.11 wireless communication protocol. Personal computer D 265 and handheld computer 260 can communicate with the other devices in the appliance based network 250 and the Internet 205. Personal computer E 270 is connected to the appliance via a physical connection, such as a cable. Personal computers D and E 265, 270 and handheld computer 260 include a user interfaces that permit users to direct the operation of the devices from a high level.

The embodiment of FIG. 2C is particularly useful in combination with the methods for obtaining software over the Internet as described herein. One example of an appliance-based network that is similar to the network of FIG. 2C is described in U.S. patent application Ser. No. 60/435,317, (the '317 patent application) filed Dec. 17, 2002, which is incorporated by reference herein.

One benefit of using an appliance-based network, such as the network disclosed in the foregoing '317 patent application is that the network appliance 255 can provide information about the associated computers of the network, such as the hardware and software resources available at the computers. Network appliance 255 can also facilitate the communication with the remote service distribution system 105 and can maintain information about the usage and licensing of the software by the computers in the local area network. As described in the '317 patent application, network appliances 255 can interact with a service platform that performs various functions, such as remote storage of data at the service, interconnectivity and collaboration with remote computers, and the like. This service can be adapted to provide the software sales channels and services that are described herein, thereby maximizing the value of the service platform and the value of the network appliances 255. Thus, according to one embodiment of the invention, the service distribution system 105 of FIG. 1 is a computer system that provides a service platform offering various services to network appliance 255 as well as any number of other network appliances in other physical locations.

III. Service Distribution to Local Device

Reference is next made to FIG. 3, which illustrates a logical flow chart 300 of a method for delivering services to a local device through a remote service distribution system. For example, the flow chart 300 could represent the process of delivering services 140 from the remote service distribution system 105 to the local device 155 via the Internet 145, as shown in the embodiment illustrated in FIG. 1. Although described in the context of the embodiment illustrated in FIG. 1, the illustrated flow chart 300 is applicable to other remote service distribution system 105 configurations and communication schemes.

Initially, a connection between the remote service distribution system 105 and the local device 155 is established (act 305). As described above with reference to FIG. 1, the remote service distribution system 105 provides a public interface 133 which is publicly accessible over the Internet 145. A local device 155 issues a request to access the public interface 133 and thereby establishes a connection between the local device 155 and the remote service distribution system 105. Once the connection is established, the hardware resources available on the local device 155 are identified (act 312). Act 312 further includes act 310, act 315, and act 320 as illustrated in FIG. 3.

Initially, an attempt is made to automatically identify the hardware resources available on the local device 155 (act 310). The hardware resources can be identified automatically in this manner if the local network of the local device is configured to maintain a data structure that includes this information. For example, if the local device 155 is associated with a network appliance 255 as illustrated in FIG. 2C, the network appliance can maintain a data structure that describes or quantifies the hardware resources and the software resources of local client 155. If the data structure exists, the information identifying the hardware resources of local client 155 is transmitted to analysis module 130. If the hardware resources are successfully identified automatically by act 310, the method proceeds to act 325 (act 315). Otherwise, if the hardware resources are not successfully identified by act 310, the method proceeds to prompt the user to manually identify the hardware resources available on the local device 155 (act 320) and then proceed to act 325.

The services that are compatible with the identified hardware resources on the local device 155 are then displayed (act 325). In order to display only the services that are compatible with the hardware resources available on the local device, the identified hardware resources are compared with the services available on the remote service distribution system 105. The services that are not compatible with the hardware resources on the local device 155 are then filtered before the available services on the remote service distribution system 105 are displayed. A request to perform one or more of the services is then received from the local device 155 (act 330). The requested services from the local device 155 include at least one initial service. As described above, an initial service includes initial routines that are performed in order to download, install, or setup a particular computer program.

The requested services are then performed in act 335. The performance of the at least one services may include directly transmitting a software package to the local device 155 such that it automatically installs itself. Alternatively, the performance may include allowing the local device 155 to access a page that enables it to manually download a particular package. If follow-up services are to be performed at a future time, information specifying that the follow-up services are to be performed is generated and stored to facilitate the follow-up services. As described above, the information specifying that the follow-up services are to be performed can be stored locally at local device 155 or can be stored by a network appliance or other computer associated with the local device. For example, if a follow-up service of automatically updating a particular software package is requested, the information necessary to establish a connection from the local device 155 to the remote service distribution system 105 is stored such that when the update is produced and is available, the follow-up service can be performed. A connection with the local device is reestablished at a later time using the communication information to perform an follow-up services (act 340).

IV. New Services and Service Updates from an Outlet

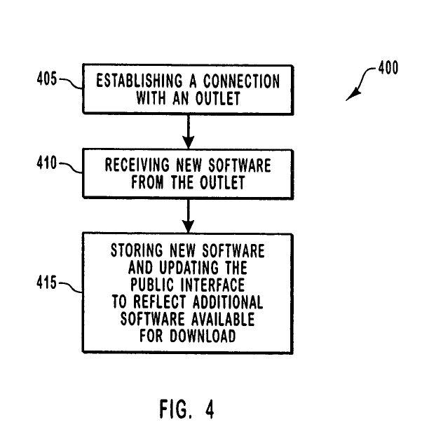

Reference is next made to FIG. 4, which illustrates a logical flow chart 400 of a method for installing additional services on a remote service distribution system from a software outlet over the Internet. For example, the flow chart 400 could represent the process of delivering new software 135 from the outlet 150 to the remote service distribution system 105 via the Internet 145, as shown in the embodiment illustrated in FIG. 1. Although described in the context of the embodiment illustrated in FIG. 1, the illustrated flow chart 400 is applicable to other remote service distribution system 105 configurations and communication schemes.

Initially, a connection between the remote service distribution system 105 and the outlet 150 is established (act 405). The act 405 of establishing a connection with the outlet 150 further includes receiving a connection request from the outlet 150 and establishing a connection with the outlet 150 via a private interface 132. Once the connection is established, a new software package 135 is received or uploaded from the outlet 150 to the remote service distribution system 105 (act 410). The new software 135 is received through the Internet 145 connection and through the private interface 132. The act 410 of receiving the new software 135 further includes receiving a new software 135 from the outlet 150 via the private interface 132 and identifying the new software 135 based on an embedded data structure. The new software 135 is then stored on the storage device 115 and the public interface 133 is updated to reflect additional software available for download (act 415). The new software is stored on the storage device 115 of the remote service distribution system 105 and the public interface 132 is adjusted to list any new services pertaining to the new software 135.

V. Local Device Resource Analysis and Suggestion of Enhancement Services

Reference is next made to FIG. 5, which illustrates a logical flow chart 500 of a method for suggesting enhancement services to a local device through a remote service distribution system. For example, the flow chart 500 could represent the process of identifying resources on the local device 155 and suggesting services that would enhance the existing resources on the local device 155, as shown in the embodiment illustrated in FIG. 1. Although described in the context of the embodiment illustrated in FIG. 1, the illustrated flow chart 500 is applicable to other remote service distribution system 105 configurations and communication schemes.

Initially, a connection between the remote service distribution system 105 and the local device 155 is established (act 505). As described above with reference to FIG. 1, the remote service distribution system 105 provides a public interface 133 which is publicly accessible over the Internet 145. A local device 155 can establish a connection with the remote service distribution system 105 as has been described above.

Once a connection is established, the remote service distribution system 105 identifies resources available on the local device 155 (step 512). Step 512 further includes act 510, act 515, act 520, act 525, act 530, and act 535. In order to identify the resources on the local device 155, it is initially determined whether the local device 155 has previously purchased services from the remote service distribution system 105 (act 510). If the local device 155 has not previously purchased services, the remote service distribution system 105 attempts to automatically identify both hardware and software resources on the local device (act 520). The analysis module 130 attempts to access a data structure on the local device 155 or on a network appliance or other computer associated with the local device that defines the hardware and software resources available on the local device 155. As noted above, in embodiments of the invention that use a network appliance 255 as described above in reference to FIG. 2C, the network appliance can maintain the data structure that defines the hardware and software resources of local device 155. If the hardware and software resources are successfully identified automatically by act 520, the method proceeds to act 540 (act 530). Otherwise, if the hardware resources are not successfully identified by act 520, the method proceeds to prompt the user to manually identify the unknown resources available on the local device 155 (act 535) and then proceed to act 540.

If the local device 155 has previously purchased services, the remote service distribution system 105 attempts to automatically identify only software resources on the local device (act 515) because the hardware resources would have been identified in the process of purchasing services. The analysis module 130 attempts to accesses a data structure on the local device 155 or on a network appliance or other computer associated with the local device that defines the software resources available on the local device 155. If the software resources are successfully identified automatically by act 515, the method proceeds to act 540 (act 525). Otherwise, if the software resources are not successfully identified by act 515, the method proceeds to prompt the user to manually identify the unknown resources available on the local device 155 (act 535) and then proceed to act 540.

Once the software and hardware resources are identified on the local device 155, the method proceeds to analyze the identified resources in relation to the available services (act 540). Services that are not compatible with the hardware resources of the local device are eliminated through the analysis performed by the analysis module 130. The analysis module 130 also compares the characteristics and requirements of the available services on the remote service distribution system 105 to determine if they would enhance resources on the local device 155. For example, if the software resources on the local device 155 include a programming language and a particular service on the remote service distribution system 105 is an expansion module for the programming language, the analysis module identifies the expansion module as a service that would enhance an existing resource. The service module 130 can also identify services that enhance hardware resources on the local device 155. For example, if the local device 155 includes a digital camera hardware resource, the analysis module 130 could identify a service that pertains to downloading a software package for interfacing with a digital camera. The list of services that would enhance resources on the local device 155 are displayed (act 550).

VI. Suitable Computing Environments

The following discussion provides an additional general description of examples of suitable computing environments in which embodiments of the present invention may be implemented. Although not required, embodiments of the invention may be described in the general context of computer-executable instructions, such as program modules, being executed by computers operating within network environments. Generally, program modules include routines, programs, objects, components, data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those skilled in the art will appreciate that embodiments of the invention may be practiced in network computing environments with many types of computer system configurations, including personal computers, hand-held devices, mobile telephones, personal digital assistants (“PDAs”), multi-processor systems, microprocessor-based or programmable consumer electronics, network PCs, minicomputers, mainframe computers, and the like. The invention may also be practiced in distributed computing environments where local and remote processing devices are linked (either by hardwired links, wireless links, or by a combination of hardwired or wireless links) through a communications network and both the local and remote processing devices perform tasks.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method of communicating with a remote service distribution system to obtain software to be installed in a local device, comprising:
at a computer associated with the local device, storing a data structure that defines hardware resources and software resources of the local device;
establishing communication with the remote service distribution system; and
requesting a service from the remote service distribution system, the service including transmission of the software to the local device, wherein information of the data structure that defines the hardware resources and software resources of the local device is transmitted to the remote service distribution system.

2. The method of claim 1, wherein the computer associated with the local device comprises a network appliance that operates as a gateway to the Internet for the local device.

3. The method of claim 1, wherein a follow-up service associated with the software is available from the remote service distribution system at a later time than the service, the method further comprising storing information at the computer specifying that the follow-up service is available.

4. The method of claim 1, wherein the follow-up service comprises an upgrade of the software.

5. The method of claim 1, wherein the follow-up service comprises an extension module of the software.

6. The method of claim 1, further comprising reestablishing communication with the remote service distribution system at said later time based on the information specifying that the follow-up service is available such that the follow-up service can be provided to the local device.

7. The method of claim 1, wherein reestablishing communication is performed automatically and without user initiation thereof.

8. A service distribution system configured to interface with a remote device in order to provide services, the system comprising:
a network interface module configured to provide an interface to the remote device;
at least one service available to the remote device; and
a resource analysis module configured to analyze resources on the remote device in relation to the at least one service.

9. The service distribution system of claim 8, further comprising a storage device that stores software packages pertaining to the at least one service.

10. The service distribution system of claim 8, wherein the network interface module is an Internet interface that connects to the Internet and provides a public interface, wherein the public interface provides limited access to the service distribution system.

11. The service distribution system of claim 8, wherein the network interface module is an Internet interface that connects to the Internet and provides a private interface, wherein the private interface provides secure access to an outlet for purposes of uploading additional software to the service distribution system.

12. The service distribution system of claim 8, wherein the network interface module is connected to the Internet via a data connection.

13. The service distribution system of claim 8, wherein the at least one service includes both initial services and follow-up services, wherein initial services are performed immediately upon request and follow-up services are performed at a later time.

14. The service distribution system of claim 13, wherein the initial services include the ability to download software packages to operate on the remote device.

15. The service distribution system of claim 13, wherein the follow-up services include automatically updating an initial service on a remote device when an update to the initial service becomes available.

16. The service distribution system of claim 8, wherein the resource analysis module is configured to identify hardware resources available on the remote device, wherein the hardware resources are analyzed in relation to the at least one service to determine which services are compatible with the remote device.

17. The service distribution system of claim 8, wherein the resource analysis module is configured to identify software resources available on the remote device, wherein the software resources are analyzed in relation to the at least one service to determine which services would enhance the identified software resources.

18. A method for delivering services to a remote device through a service distribution system, comprising:
establishing a connection with a remote device;
identifying hardware resources on the remote device;
displaying a list of available services that are compatible with the hardware resources on the remote device;
receiving a request to perform at least one service including at least one initial service; and
performing the at least one service.

19. The method of claim 18, further comprising reestablishing a connection with the remote device and performing any requested follow-up services.

20. The method of claim 18, further comprising, if the hardware resources available on the remote device were not fully identified, prompting a user of the remote device to manually input the hardware resources available on the remote device.

21. The method of claim 18, wherein establishing a connection with a remote device further comprises providing a public interface that is publicly accessible over the Internet and establishing a connection with a remote device via the public interface.

22. The method of claim 18, wherein identifying the hardware resources available on the remote device further comprises accessing a data structure associated with remote device defining the hardware resources available on the remote device.

23. The method of claim 18, wherein displaying a list of available services that are compatible with the hardware resources available on the remote device further comprises analyzing available services in relation to the hardware resources available on the remote device.

24. The method of claim 18, wherein the request to perform at least one service is received at the service distribution system from the remote device via the Internet.

25. The method of claim 18, wherein performing the at least one initial service comprises transmitting at least one software package to the local device.

26. At a service distribution system, a method for suggesting enhancement services to a remote device, comprising:
establishing a connection with the remote device;
identifying resources available on the remote device;
analyzing resources available on the remote device in relation to services available on the service distribution system; and
displaying a list of services that would enhance the resources available on the remote device.

27. The method of claim 23, wherein establishing a connection with the remote device further includes providing an interface that is publicly accessible over the Internet and establishing a connection with a remote device via the interface.

28. The method of claim 23, wherein identifying hardware and software resources available on the remote device further includes the acts of:
analyzing whether the remote device has previously connected to the service distribution system;
if the remote device has previously connected to the service distribution system, identifying software resources available on the remote device and accessing a data structure including available hardware resources of the remote device; and
if the remote device has not previously connected to the service distribution system, identifying software and hardware resources available on the remote device by receiving information specifying the software and hardware resources from the remote device.

29. The method of claim 23, wherein analyzing the hardware and software resources available on the remote device in relation to a set of services available on the service distribution system further comprises eliminating services which would not be compatible with hardware resources available on the remote device and determining if any of the non-eliminated services would enhance software resources on the remote device.
